(19) United States
(12) Patent Application Publication
(10) Pub. No.: US 2013/0161298 A1
(43) Pub. Date: Jun. 27, 2013

(54) Plasma Torch Device Using Moving Magnets

(71) Applicants: Jyh-Ming Yan, Taoyuan County (TW); Ming-Song Yang, Taipei City (TW); Chin-Ching Tzeng, New Taipei City (TW); Yo-Ming Chang, Kaohsiung City (TW); Kuo-Chao Liang, Chiayi County (TW); Chen-Yuan Hsu, Pingtung County (TW); Shao-Yang Lu, Taoyuan County (TW)

(72) Inventors: Jyh-Ming Yan, Taoyuan County (TW); Ming-Song Yang, Taipei City (TW); Chin-Ching Tzeng, New Taipei City (TW); Yo-Ming Chang, Kaohsiung City (TW); Kuo-Chao Liang, Chiayi County (TW); Chen-Yuan Hsu, Pingtung County (TW); Shao-Yang Lu, Taoyuan County (TW)

(73) Assignee: ATOMIC ENERGY COUNCIL-INSTITUTE OF NUCLEAR ENERGY RESEARCH, Taoyuan County (TW)

(21) Appl. No.: 13/591,988

(22) Filed: Aug. 22, 2012

(30) Foreign Application Priority Data
Dec. 22, 2011 (TW) 100147997

(51) Int. Cl. B23K 10/00

(52) U.S. Cl. 219/121.52

(57) ABSTRACT

The present invention provides a plasma torch device. The device comprises a front electrode, a back electrode and a vortex flow generator. The torch roots of the back electrode are moved by fixed magnets. By controlling the magnets coordinated with vortex air flow, the torch roots are moved back and forth periodically on inner surface of the back electrode. The torch roots do not stay at the same place for long for preventing increasing local heat burden of the electrode. Thus, life time and maintenance cycle of the electrode is prolonged with reduced operational cost of plasma torch and enhanced reliability of the device.

### TECHNICAL FIELD OF THE INVENTION

The present invention relates to a plasma torch; more particularly, relates to controlling moving of torch roots by magnets.

### DESCRIPTION OF THE RELATED ART

High-temperature plasma torch is used for metal melting, nano-particle spraying and modification of material surface. In the field of environmental protection, plasma torch can be used for handling radioactive waste, heavy-metal polluted contaminants, and slag of incinerator.

For moving torch roots, torch-air blasting and spiral magnets are used. However, the spiral magnets do not make the torch roots move widely in a big area on electrode surface. As a result, local heat burden of the electrode is greatly increased and life time of the electrode is shortened. Hence, the prior art does not fulfill all users' requests on actual use.

### SUMMARY OF THE INVENTION

The main purpose of the present invention is to provide a plasma torch device with characteristics of easy installation, low cost and prevention of electrode's melting.

The second purpose of the present invention is to use an eccentric motor to drive magnets for greatly prolonging life time of magnet and reducing operational cost.

To achieve the above purposes, the present invention is a plasma torch device using moving magnets, comprising a front electrode, a back electrode and a vortex flow generator, where the front electrode is fixed on the vortex flow generator with a fixing plate at an end; a feeding input is set at another; an cooling sleeve is set at a first outer layer; and, thus, a torch front module of the front electrode is formed; where the back electrode is fixed on the vortex flow generator with another fixing plate; a fixed magnet seat is set on a second outer layer; the fixed magnet seat has a cam device inside of the fixed magnet; another cooling sleeve is set on a third outer layer; a transparent window is set at an end; thus, a torch back module of the back electrode is formed; each of the cooling sleeves comprises a magnetic rod and a motor driving device; and the motor driving device drives magnets; and where the vortex flow generator is set between the front electrode and the back electrode; the vortex flow generator comprises an outer ring device and two isolating plates; the isolating plates control a hole size to access a working air flow; and the vortex flow generator generates vortex flow with the working air flow. Accordingly, a novel plasma torch device using moving magnets is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the sectional view showing the preferred embodiment according to the present invention;

FIG. 2 is the sectional view showing the magnet seat;

FIG. 3 is the top-down view showing the magnet seat;

FIG. 4 is the explosive sectional view showing the vortex flow generator;

FIG. 5 is the top-down view showing the outer ring device; and

FIG. 6 is the top-down view showing the isolating plate.

### DESCRIPTION OF THE PREFERRED EMBODIMENT

The following description of the preferred embodiment is provided to understand the features and the structures of the present invention.

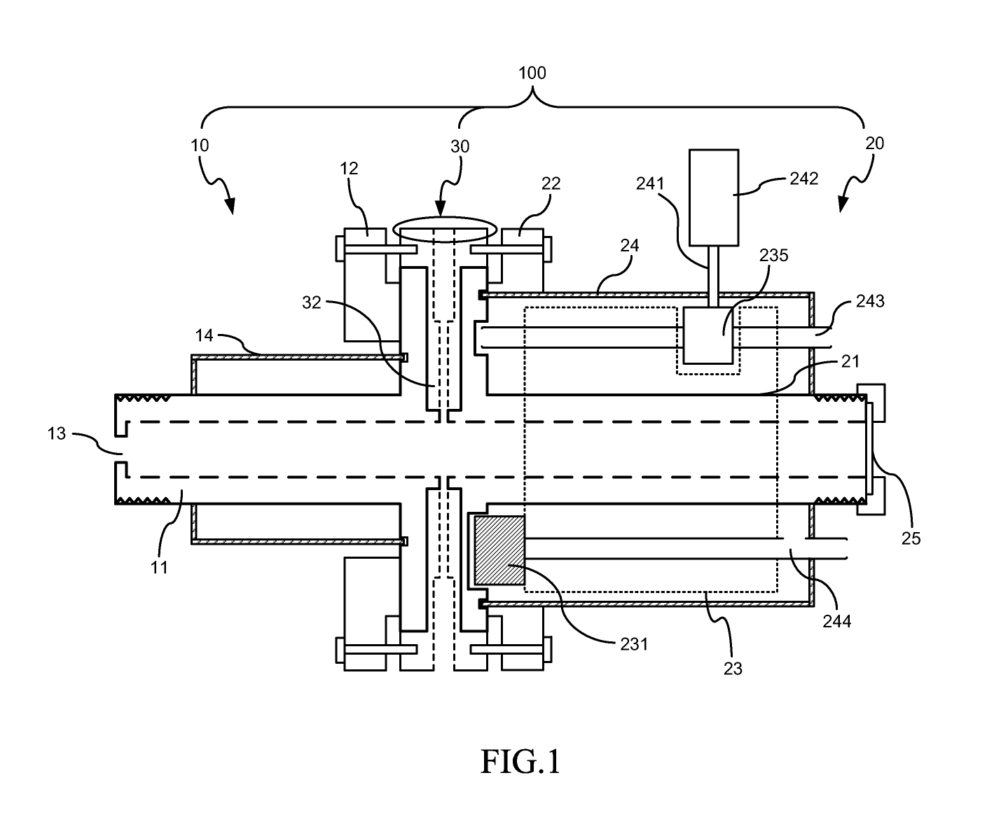

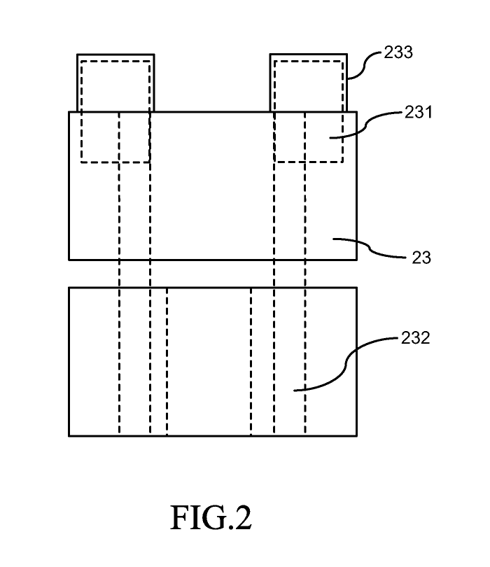

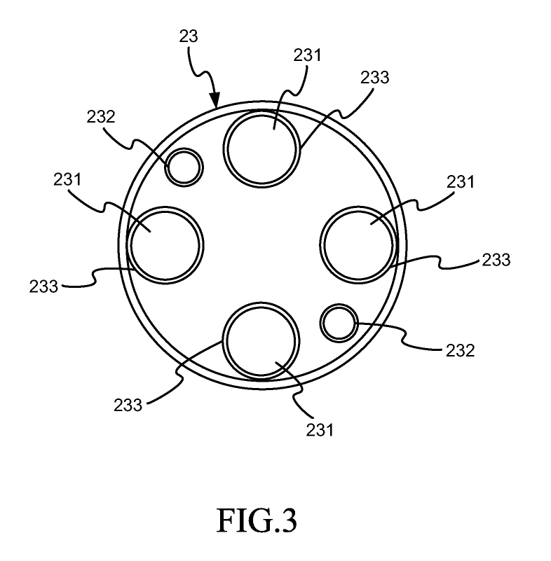

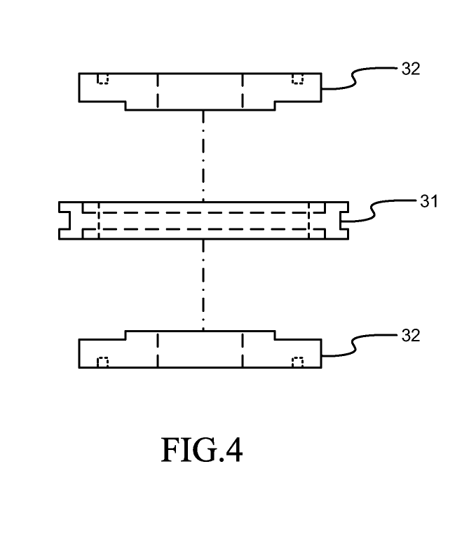

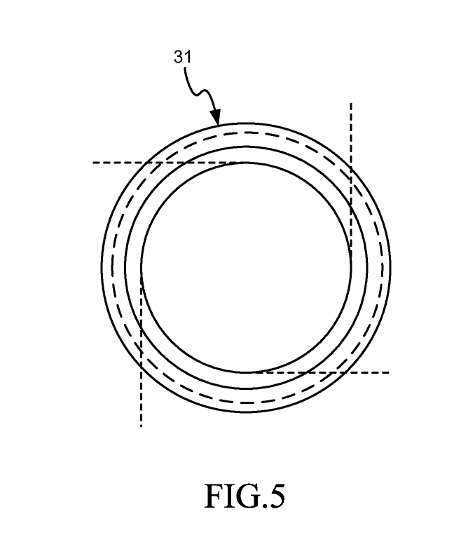

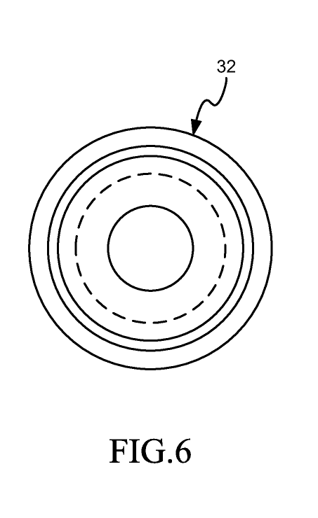

Please refer to FIG. 1 to FIG. 6, which are a sectional view showing a preferred embodiment according to the present invention; a sectional view showing a magnet seat; a top-down view showing the magnet seat; an explosive sectional view showing a vortex flow generator; a top-down view showing a outer ring device; and a top-down view showing an isolating plate. As shown in the figures, the present invention is a plasma torch device 100 using moving magnets, comprising a front electrode 11, a back electrode 21 and a vortex flow generator 31, which can be easily installed and run with low cost and reduce possibility of melting of electrodes.

The front electrode 11 is fixed on the vortex flow generator 30 with a fixing plate 12 at an end; a feeding input 13 is set at another end; a cooling sleeve 14 is set at a first outer layer of the front electrode 11; and, thus, a torch front module 10 is formed.

The back electrode 21 is fixed on the vortex flow generator 30 with another fixing plate 22; a fixed magnet seat 23 is set on a second outer layer of the back electrode 21; the fixed magnet seat 23 contains a cam device 235 inside; another cooling sleeve 24 is obtained on a third outer layer of the back electrode 21; a transparent window 25 is set at an end of the back electrode 21; and, thus, a torch back module 20 is formed. Therein, the fixed magnet seat 23 comprises a plurality of fixed magnets 231 and two penetrating fixing holes 232; an oval trough 234 is obtained at a side-wall of the fixed magnet seat 23; each of the cooling sleeves 24 comprises a magnetic rod 241, a motor driving device 242, an input tube 243 and an output tube 244; the motor driving device 242 drives magnets; and, the input tube 243 and the output tube 244 are used for inputting and outputting cooling water.

The vortex flow generator 30 is set between the front electrode 10 and the back electrode 20 for generating vortex flow with a working air flow; and, the vortex flow generator 30 comprises an outer ring device 31 and two isolating plates 32. Therein, the isolating plate 32 is made of polytetrafluoroethene (PTFE), polyetheretherketone (PEEK), ceramics or quartz.

Therein, the front electrode 11 and the back electrode 21 are cylindrical tubes made of copper (Cu), hafnium (Hf), tungsten (W) or zirconium (Zr) or one of their alloys; and, the fixed magnet seat 23 can be moved by a driving device, like a belt, a hydraulic cylinder or a pneumatic cylinder.

On assembling the present invention 100, the front electrode 11 is coaxially fixed on the vortex flow generator 30 with a screw having reverse threads. The first outer layer is coaxially slipped over the cooling sleeve 14 to be fixed with threads for forming the torch front module 10. The back electrode 21 is coaxially fixed on the vortex flow generator 30 with another screw having reverse threads. The second outer layer is coaxially slipped over the fixed magnet seat 23; and, then, the third outer layer is coaxially slipped over the cooling sleeve 24. The transparent window 25 is set at an air input at a back end with coordination of threads to be fixed for forming the torch back module 20. The fixed magnet seat 23 is made of a non-magnetic material and is buried with a plurality of fixed magnets 231 inside. A non-magnetic cap is covered on a protruding part of the fixed magnet seat 233. The penetrating fixing holes 232 are combined with the magnetic rods 241 contained in the cooling sleeve 24. The fixed magnet seat 23 is moved back and forth in the cooling sleeve 24 by the cam device 235 in the oval trough 24. The vortex flow generator 30 is set between the torch front module 10 and the torch back module 20. By adjusting a space between the two isolating plates 32 and an amount of air inputted, a vortex flow field can be changed.

On using the present invention, the motor driving device 242 installed in the cooling sleeve 24 of the torch back module 20 is combined with the eccentric motor 235 to drive the fixed magnet seat 23 for moving. By the moving of the fixed magnets 231, torch roots are pulled to be moved back and forth in a wide area on the inner surface of the back electrode 21 for preventing melting of the electrode. Thus, the live time of the electrode is prolonged and operation cost is reduced.

Hence, the present invention controls moving of plasmas on electrode through a design of cam device to guide magnets and air flow for preventing melting of electrode by moving the magnets back and forth in a big area on an inner surface of the back electrode for preventing staying at a position for a long time. As a result, the electrode does not have heat burden increased at any local position; life time and maintenance cycle of the electrode are prolonged; and, operational cost of plasma torch is reduced with reliability increased.

To sum up, the present invention is a plasma torch device using moving magnets, where a cam device is used to guide magnets and a flow field for moving torch root back and forth in a big area on inner surface of an electrode; and, thus, melting of the electrode is prevented and life time and reliability of the electrode are further prolonged and enhanced with operational cost saved.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A plasma torch device using moving magnets, comprising a front electrode, a back electrode and a vortex flow generator,
wherein said front electrode is fixed on said vortex flow generator with a fixing plate at an end of said front electrode; a feeding input is obtained at another end of said front electrode; a cooling sleeve is obtain at a first outer layer of said front electrode; and, thus, a torch front module of said front electrode is obtained;
wherein said back electrode is fixed on said vortex flow generator with another fixing plate; a fixed magnet seat is obtained on a second outer layer of said back electrode; said fixed magnet seat has a cam device inside of said fixed magnet; another cooling sleeve is obtained on a third outer layer of said back electrode; a transparent window is obtained at an end of said back electrode; thus, a torch back module of said back electrode is obtained; each of said cooling sleeves comprises a magnetic rod and a motor driving device; and said motor driving device drives magnet; and
wherein said vortex flow generator is obtained between said front electrode and said back electrode; said vortex flow generator comprises an outer ring device and two isolating plates; said isolating plates control a working air flow; and said vortex flow generator generates vortex flow with said working air flow.

2. The device according to claim 1,
wherein said front electrode and said back electrode are cylindrical tubes made of a material selected from a group consisting of a metal and an alloy of said metal and said metal is selected from a group consisting of copper (Cu), hafnium (Hf), tungsten (W) and zirconium (Zr).

3. The device according to claim 1,
wherein screws are used to separately fix said front electrode and said back electrode on said vortex flow generator with coaxially reverse threads of said screws.

4. The device according to claim 1,
wherein said front electrode is fixed on said vortex flow generator through said fixing plate with a screw; and
said first outer layer is coaxially slipped over said cooling sleeve to be fixed with threads to obtain said torch front module.

5. The device according to claim 1,
wherein said back electrode is fixed on said vortex flow generator through said fixing plate with a screw; said second outer layer is coaxially slipped over said fixed magnet seat; then, said third outer layer is coaxially slipped over said cooling sleeve; and, said transparent window is obtained at said end of said back electrode with coordination of threads to be fixed to obtain said torch back module.

6. The device according to claim 1,
wherein said fixed magnet seat is made of a non-magnetic material; said fixed magnet seat comprises a plurality of fixed magnets and two penetrating fixing holes; an oval trough is obtained at a side-wall of said fixed magnet seat; said plurality of fixed magnets is located in said fixed magnet seat; a non-magnetic cap is covered on a protruding part of said fixed magnet seat;
said penetrating fixing holes are combined with magnetic rods in said cooling sleeve; and said fixed magnet seat is moved back and forth in said cooling sleeve through said cam device obtained in said oval trough.

7. The device according to claim 1,
wherein an input tube and an output tube are contained in said cooling sleeve to input and output cooling water, respectively.

8. The device according to claim 1,
wherein said fixed magnet seat is moved by a driving device selected from a group consisting of a belt, a hydraulic cylinder and a pneumatic cylinder.

9. The device according to claim 1,
wherein said vortex flow generator changes a vortex flow field by a space between said isolating plates and an input amount of said working air flow.

10. The device according to claim 1,
wherein said isolating plate is made of a material selected from a group consisting of polytetrafluoroethene (PTFE), polyetheretherketone (PEEK), ceramics and quartz.

11. The device according to claim 1,
wherein said transparent window is made of quartz glass.

12. The device according to claim 1,
wherein said motor driving device is an eccentric motor.
